(19) United States
(12) Patent Application Publication
(10) Pub. No.: US 2025/0196575 A1
(43) Pub. Date: Jun. 19, 2025

(54) AIR CONDITIONER FOR VEHICLE AND METHOD FOR CONTROLLING SAME

(71) Applicant: HANON SYSTEMS, Daejeon (KR)

(72) Inventors: Il Hwa LEE, Daejeon (KR); In Seok SONG, Daejeon (KR); Hyeong Su OH, Daejeon (KR); Jeong Yeop LEE, Daejeon (KR); Jung Hyun KIM, Daejeon (KR)

(21) Appl. No.: 18/921,314

(22) Filed: Oct. 21, 2024

(30) Foreign Application Priority Data
Dec. 13, 2023 (KR) 10-2023-0180684

(51) Int. Cl. B60H 1/00

(52) U.S. Cl. CPC B60H 1/00835

(57) ABSTRACT

Air conditioner for vehicle and method for controlling the same, having a control logic capable of preventing the noise caused by a gap between doors and a blower pressure of an air blowing device during mode changes that a specific door is closed. The air conditioner for a vehicle includes an air-conditioning case having an air passage formed therein and a plurality of air discharge ports; a cooling heat exchanger and a heating heat exchanger situated in the air passage of the air-conditioning case; an air blowing device having a blower blowing air into the interior of the air-conditioning case; a plurality of mode doors adjusting the opening degree of the air discharge ports, and a control unit controlling the operation of the mode doors, which changes the air-conditioning mode after decreasing the airflow of the blower when changing the air-conditioning mode to close at least one mode door.

### BACKGROUND OF THE INVENTION

### Field of the Invention

The present invention relates to an air conditioner for a vehicle and a method for controlling the same, and more specifically, to an air conditioner for a vehicle and a method for controlling the same, which can reduce the closing noise of a defrost door that adjusts the opening of a defrost vent.

### Background Art

In general, an air conditioner for a vehicle is an apparatus that introduces external air into the interior or circulates the internal air to heat or cool the air, thereby heating or cooling the interior. The air conditioner for a vehicle includes an air-conditioning case, an evaporator provided inside the air-conditioning case for a cooling action, and a heater core for a heating action. The air cooled or heated by the evaporator or the heater core is selectively blown to various parts inside the vehicle.

Referring to FIG. 1, a conventional air conditioner 1 for a vehicle includes an air-conditioning case 10, an air blowing device, an evaporator 2, a heater core 3, a temperature door 15, and a plurality of mode doors. The mode doors include a defrost door 16, a vent door 17, a floor door 18, and a console door 19.

An air inflow port is formed on an inlet side of the air-conditioning case 10, and a plurality of air discharge ports are formed on an outlet side. The air discharge ports include a defrost vent 11 controlled in the opening degree by the defrost door 16, a face vent 12 controlled in the opening degree by the vent door 17, a floor vent 13 controlled in the opening degree by the floor door 18, and a console vent 14 controlled in the opening degree by the console door 19.

The air blowing device is provided with a blower and is connected to the air inflow port of the air-conditioning case 10 and functions to blow internal or external air into an air passages inside the air-conditioning case 10. Additionally, the evaporator 2 and the heater core 3 are sequentially provided in an air flow direction within the air passages of the air-conditioning case 10. The temperature door 15 is positioned between the evaporator 2 and the heater core 3, and adjusts the opening degree of a cold air passage bypassing the heater core 3 and the opening degree of a warm air passage passing through the heater core 3, thus controlling the air temperature.

In a cooling mode, the temperature door 15 opens the cold air passage and closes the warm air passage. Consequently, the air blown by the air blowing device is cooled by exchanging heat with a refrigerant flowing inside the evaporator 2 while passing through the evaporator 2, and then, flows toward a mixing chamber through the cold air passage. Thereafter, the air is selectively discharged into the interior of the vehicle through the air discharge ports opened according to a specific air-conditioning mode, thereby cooling the interior of vehicle.

In a heating mode, the temperature door 15 closes the cold air passage and opens the warm air passage. Consequently, the air blown by the air blowing device passes through the evaporator 2 and then is heated by exchanging heat with a coolant flowing inside the heater core 3 while passing the heater core 3 through the warm air passage. Next, the heated air flows toward the mixing chamber. Thereafter, the air is selectively discharged into the interior of the vehicle through the air discharge ports opened according to a specific air-conditioning mode, thereby heating the interior of vehicle.

The air conditioner 1 for a vehicle presents various air-conditioning modes based on operation angles of the mode doors. That is, the air-conditioning modes include a vent mode which discharges air only to the face vent 12, a bilevel mode which discharges some air to the face vent 12 and some air to the floor vent 13, a floor mode which discharges air only to the floor vent 13, a mix mode which discharges some air to the defrost vent 11 and some air to the floor vent 13, and a defrost mode which discharges air only to the defrost vent 11.

As illustrated in FIG. 1, in the mix mode, the vent door 17 and the console door 19 are closed, and the floor door 18 and the defrost door 16 are opened. The air blown from the air blowing device is controlled to pass through the evaporator 2 and the heater core 3 and to be discharged to the floor vent 13 and the defrost vent 11. Furthermore, referring to FIG. 2, in the vent mode, the defrost door 16, the floor door 18, and the console door 19 are closed, and only the vent door 17 is opened.

The conventional air conditioner 1 for a vehicle has a problem in that noise occurs due to the gap between the doors and the blower pressure of the air blowing device when the defrost door 16 closes. The defrost door 16 can be connected to the vent door 17 by power transmission means such as a cam. The noise occurring when the defrost door 16 is closed is easily perceptible when the blower speed of the air blowing device is relatively low. That is, the conventional air conditioner 1 for a vehicle generates noise under the condition that the blower speed is low when changing the air-conditioning mode that the defrost door 16 is closed.

### SUMMARY OF THE INVENTION

Accordingly, the present invention has been made to solve the above-mentioned problems occurring in the prior arts, and it is an objective of the present invention to provide an air conditioner for a vehicle and a method for controlling the same, which have a control logic capable of preventing the noise caused by a gap between doors and a blower pressure of an air blowing device during mode changes that a specific door is closed.

To accomplish the above object, according to the present invention, there is provided an air conditioner for a vehicle including: an air-conditioning case having an air passage formed therein and a plurality of air discharge ports; a cooling heat exchanger and a heating heat exchanger provided in the air passage of the air-conditioning case; an air blowing device having a blower which blows air into the interior of the air-conditioning case; a plurality of mode doors adjusting the opening degree of the air discharge ports; and a control unit controlling the operation of the mode doors, wherein the control unit changes the air-conditioning mode after decreasing the airflow of the blower when changing the air-conditioning mode to close at least one mode door.

The control unit returns the airflow of the blower to the original state after the completion of the air-conditioning mode change.

The air discharge ports include a defrost vent for blowing air towards the window, a face vent for blowing air towards the face, and a floor vent for blowing air towards the feet. The mode doors include a defrost door which adjusts the opening degree of the defrost vent, and one mode door is the defrost door.

The control unit reduces the airflow of the blower when the speed of the blower is below a reference speed and the defrost door moves to be closed.

The control unit reduces the blower driving voltage at a predetermined voltage rate per second.

The control unit increases the blower driving voltage at a predetermined voltage rate per second when returning the airflow of the blower to the original state after the completion of the air-conditioning mode change.

The control unit maintains the voltage of the blower displayed externally unchanged while reducing the blower driving voltage.

When the air-conditioning mode is changed from a floor mode to a bilevel mode, or from a mix mode to a vent mode, or from a mix mode to a bilevel mode, or from a defrost mode to a vent mode, or from a defrost mode to a bilevel mode, the control unit changes the air-conditioning mode after decreasing the airflow of the blower.

In another aspect of the present invention, there is provided a method for controlling an air conditioner for a vehicle including the steps of: determining whether a defrost door moves to be closed; determining whether the speed of a blower of an air blowing device is below a reference speed; reducing the airflow of the blower by a control unit when the speed of the blower is below a reference speed and the defrost door moves to be closed; and changing an air-conditioning mode after reducing the airflow of the blower by the control unit.

The control unit returns the airflow of the blower to the original state after the completion of the air-conditioning mode change.

The control unit reduces the blower driving voltage at a predetermined voltage rate per second.

The control unit increases the blower driving voltage at a predetermined voltage rate per second when returning the airflow of the blower to the original state after the completion of the air-conditioning mode change.

The control unit maintains the voltage of the blower displayed externally unchanged while reducing the blower driving voltage.

The air conditioner for a vehicle and the method for controlling the same according to the present invention can deliberately reduce the blower speed of the air blowing device just before the defrost door is about to close, thereby reducing noise generated at the moment of closing the defrost door by the pressure of strong air.

Furthermore, the control unit controls to reduce the blower speed when the blower speed is below a reference speed, thus the blower speed is reduced only in environments where the noise when the defrost door is closed is audible to passengers. Ultimately, the control unit does not perform control to reduce the blower speed unnecessarily but controls to reduce the blower speed only in environments where the noise is audible to passengers, thereby realizing an efficient noise reduction logic.

In addition, when the airflow is reduced due to a decrease of the blower speed or when the airflow is increased due to an increase of the blower speed, there is actually no change in airflow displayed on the display, thus preventing passenger confusion and effectively preventing only noise caused by the defrost door.

### BRIEF DESCRIPTION OF THE DRAWINGS

FIG. 1 is a side sectional view illustrating a mix mode of a conventional air conditioner for a vehicle.

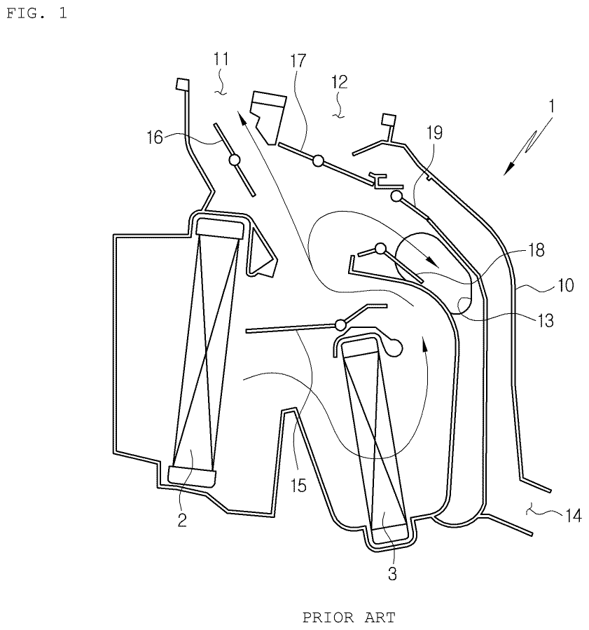

FIG. 2 is a side sectional view illustrating a vent mode of the conventional air conditioner for a vehicle.

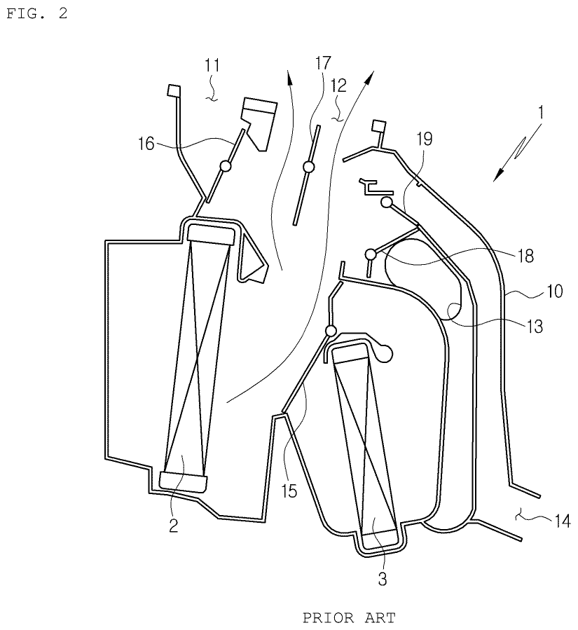

FIG. 3 is a side sectional view illustrating an air conditioner for a vehicle according to an embodiment of the present invention.

FIG. 4 is a view illustrating a floor mode of the air conditioner for a vehicle according to an embodiment of the present invention,

FIG. 5 is a view illustrating a bilevel mode of the air conditioner for a vehicle according to an embodiment of the present invention,

FIG. 6 is a view illustrating a mix mode of the air conditioner for a vehicle according to an embodiment of the present invention,

FIG. 7 is a view showing the vent mode of an air conditioner for a vehicle according to an embodiment of the present invention,

FIG. 8 is a view illustrating a defrost mode of the air conditioner for a vehicle according to an embodiment of the present invention,

FIG. 9 is a flowchart showing a method for controlling an air conditioner for a vehicle according to an embodiment of the present invention.

### DETAILED DESCRIPTION OF THE PREFERRED EMBODIMENT

Hereinafter, the technical configuration of an air conditioner for a vehicle and a method for controlling the same will be described in detail in accordance with the attached drawings.

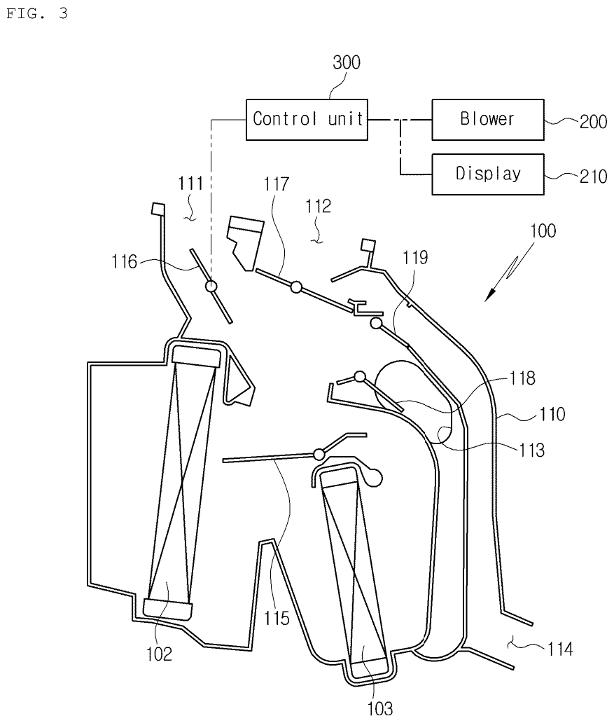

As illustrated in FIGS. 3 to 9, the air conditioner 100 for a vehicle according to an embodiment of the present invention includes an air-conditioning case 110, an air blowing device, a cooling heat exchanger, a heating heat exchanger, a temperature door 115, a plurality of mode doors, a power source, and a control unit 300.

The air-conditioning case 110 has an air inflow port for introducing air and a plurality of air discharge ports for discharging air into the interior of the vehicle. An air passage connecting the air inflow port and the air discharge ports is formed inside the air-conditioning case 110. The air blowing device is connected to the air inflow port of the air-conditioning case 110, allowing internal or external air to be selectively introduced into the air passage of the air-conditioning case 110.

The air blowing device includes a blower 200, which rotates at high speed by a motor. The air blowing device is connected to the air inflow port of the air-conditioning case 110 to blow internal air or external air into the air passages of the air-conditioning case 110 according to the rotation of the blower 200. The speed of the blower 200 is controlled by the control unit 300, and the blower speed is controlled from low level to high level to determine the airflow. The speed control of the blower 200 can be achieved by adjusting the drive voltage transmitted to the blower 200 by the control unit 300.

Furthermore, the air discharge ports of the air-conditioning case 110 include a defrost vent 111, a face vent 112, a floor vent 113, and a console vent 114. In this case, the defrost vent 111 is an outlet for blowing air towards the window, the face vent 112 is an outlet for blowing air towards the passengers' faces, the floor vent 113 is an outlet for blowing air towards the passengers' feet, and the console vent 114 is an outlet for blowing air to the rear seats of the vehicle.

The cooling heat exchanger is located in the air passage inside the air-conditioning case 110, performs a cooling action, and may be an evaporator 102. A refrigerant flowing inside the evaporator 102 and the air passing through the evaporator 102 exchange heat with each other to cool the air. Furthermore, the heating heat exchanger is located in the air passage inside the air-conditioning case 110, performs a heating action, and may be a heater core 103.

A coolant flowing inside the heater core 103 and the air passing through the heater core 103 exchange heat with each other to heat the air. The heater core 103 is arranged in a warm air passage, namely, downstream of the evaporator 102 in an air flow direction. A PTC heater or other electric heaters may be further included in the warm air passage. Alternatively, the heating heat exchanger may be configured as a condenser type heat exchanger which exchanges heat between the refrigerant and the air to heat the interior.

The temperature door 115 is situated between the evaporator 102 and the heater core 103, and adjusts the amount of cold air bypassing the heater core 103 after passing through the evaporator 102 and the amount of warm air passing through the heater core 103 after passing through the evaporator 102, thereby adjusting the temperature of the air discharged into the interior of the vehicle.

The mode doors, which adjust the opening degree of the plurality of air discharge ports, are provided in multiple. The mode doors include a defrost door 116, a vent door 117, a floor door 118, and a console door 119. In this case, the defrost door 116 adjusts the opening degree of the defrost vent 111, and the vent door 117 adjusts the opening degree of the face vent 112. Additionally, the floor door 118 adjusts the opening degree of the floor vent 113, and the console door 119 adjusts the opening degree of the console vent 114.

The power source, which operates the doors, can be directly connected to the defrost door 116 to rotate the defrost door 116, or can be connected to the power transmission means such as a cam to rotate the defrost door 116 and the vent door 117 by linking the defrost door 116 and the vent door 117. In present embodiment, the power source is comprised of an actuator directly connected to the defrost door 116.

The control unit 300, which controls the operation of the mode doors, when the air-conditioning mode is changed to close at least one mode door, decreases the airflow of the blower 200 of the air blowing device, and then, changes the air-conditioning mode. Additionally, after completing the air-conditioning mode change, the control unit 300 controls to return the speed of the blower 200 to the original state. In this case, one of the mode doors is the defrost door 116, but may be any other mode door.

That is, when the speed of the blower 200 is below a reference speed and the defrost door 116 moves to be closed, the control unit 300 controls to decrease the airflow of the blower 200. In this case, the control unit 300 decreases the drive voltage of the blower 200 at a predetermined voltage ratio per second. Additionally, when the speed of the blower 200 is returned to the original state after completing the air-conditioning mode change, the control unit 300 increases the drive voltage of the blower 200 at a predetermined voltage ratio per second.

When the defrost door 116 rotates from an open state to a closed state, a “whoosh” noise inevitably occurs due to the wind pressure. Just before the defrost door 116 is about to close, the control unit 300 of the present invention deliberately reduces the speed of the blower 200 of the air blowing device. Therefore, the air conditioner for a vehicle according to the present invention can prevent noise caused at the moment when the defrost door 116 is closed by the strong air pressure from the blower 200.

Furthermore, the control unit 300 controls to reduce the speed of the blower 200 when the speed of the blower 200 is below a reference speed. Accordingly, the control unit 300 controls to reduce the speed of the blower 200 only in environments where the closing noise of the defrost door 116 is audible to passengers. Finally, the control unit 300 does not perform the action to reduce the speed of the blower 200 unnecessarily but controls to reduce the speed of the blower 200 only in environments where the noise is audible to passengers, thus realizing an effective noise reduction logic.

Additionally, while the driving voltage of the blower 200 is reduced, the control unit 300 maintains the display 210 voltage of the blower displayed externally unchanged. That is, when the speed of the blower 200 is below the reference speed and the defrost door 116 moves in a direction to close the defrost door 116, the control unit 300 does not change the voltage of the display 210 indicating airflow to the outside but reduces only the driving voltage of the blower 200. Thereafter, the control unit 300 changes the air-conditioning mode and increases the driving voltage of the blower 200 to the original state.

Through the above configuration, when the speed of the blower 200 is reduced resulting in decreased airflow or when the speed of the blower 200 is increased resulting in increased airflow, there is actually no change in airflow displayed on the display 210, thus preventing passenger confusion and effectively preventing only the noise caused by the defrost door 116.

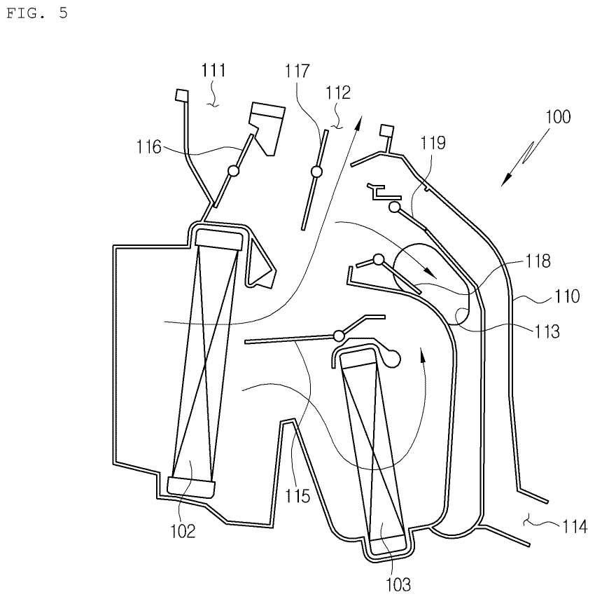

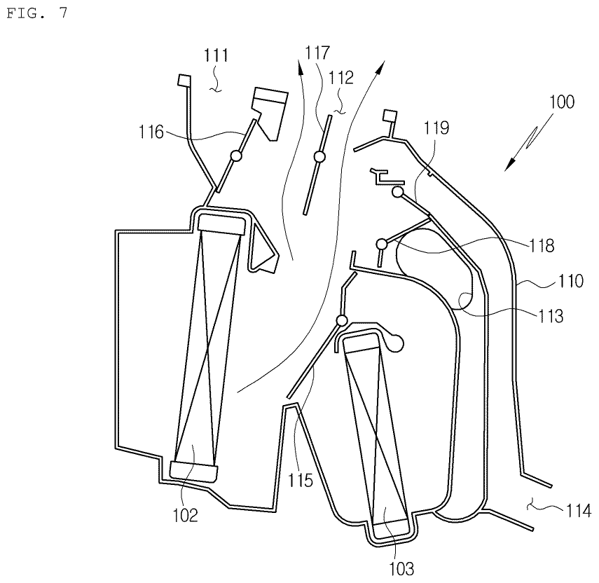

Meanwhile, the air-conditioning modes implemented through the air conditioner 100 include a vent mode, a bilevel mode, a floor mode, a mix mode, and a defrost mode. As illustrated in FIG. 7, the vent mode is a mode that discharges air only to the face vent 112. As illustrated in FIG. 5, the bilevel mode is a mode that discharges air to both the face vent 112 and the floor vent 113.

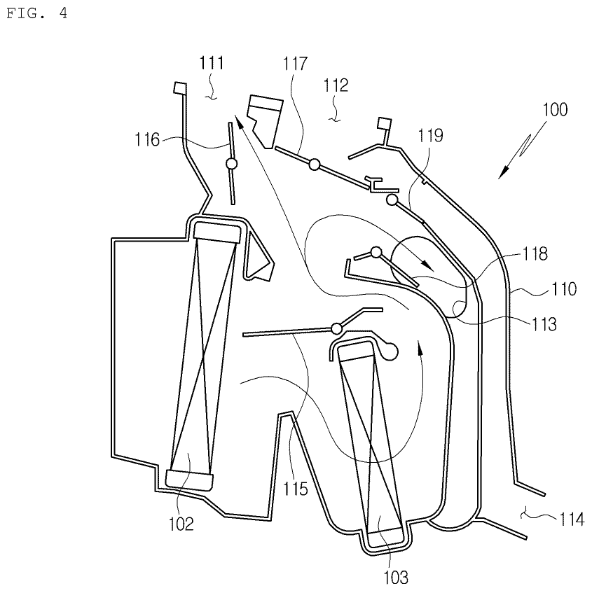

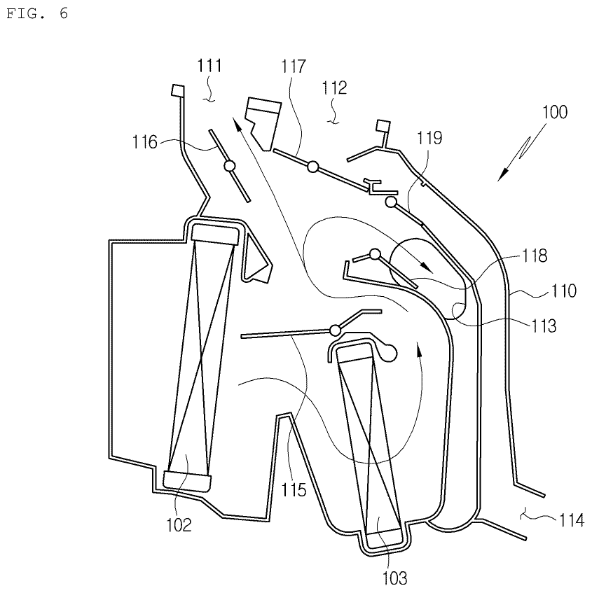

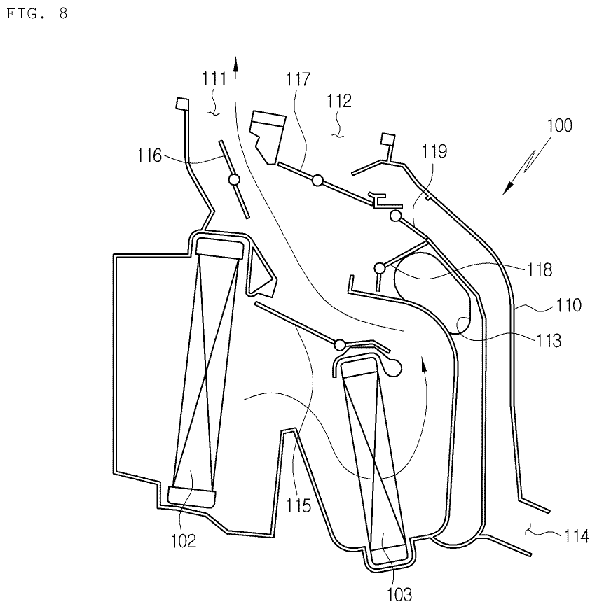

Additionally, as illustrated in FIG. 4, the floor mode is a mode that opens the floor vent 113 and opens the defrost vent 111 very slightly. Furthermore, as illustrated in FIG. 6, the mix mode is a mode that discharges air to both the defrost vent 111 and the floor vent 113. As illustrated in FIG. 8, the defrost mode is a mode that discharges air only to the defrost vent 111. In both the floor mode and the mix mode, both the defrost vent 111 and the floor vent 113 are opened, but the floor mode opens the defrost vent 111 to a lesser extent compared to the mix mode.

Meanwhile, the case that the defrost door 116 moves from an open state to a closed state, is when the air-conditioning mode is changed from the floor mode to the bilevel mode, or from the mix mode to the vent mode, or from the mix mode to the bilevel mode, or from the defrost mode to the vent mode, or from the defrost mode to the bilevel mode. That is, when the air-conditioning mode is changed from the floor mode to the bilevel mode, or from the mix mode to the vent mode, or from the mix mode to the bilevel mode, or from the defrost mode to the vent mode, or from the defrost mode to the bilevel mode, the control unit 300 changes the air-conditioning mode after reducing the speed of the blower 200.

Meanwhile, a method for controlling the air conditioner for a vehicle according to an embodiment of the present invention includes the steps of: determining whether the defrost door 116 moves to the direction to be closed; determining whether the speed of the blower 200 of the air blowing device is below the reference speed; reducing the speed of the blower 200 by a control unit 300 when the speed of the blower 200 is below the reference speed and the defrost door 116 moves to the direction to be closed; changing the air-conditioning mode after reducing the speed of the blower 200 by the control unit 300; and returning the speed of the blower 200 to the original state after completing the air-conditioning mode change by a control unit 300.

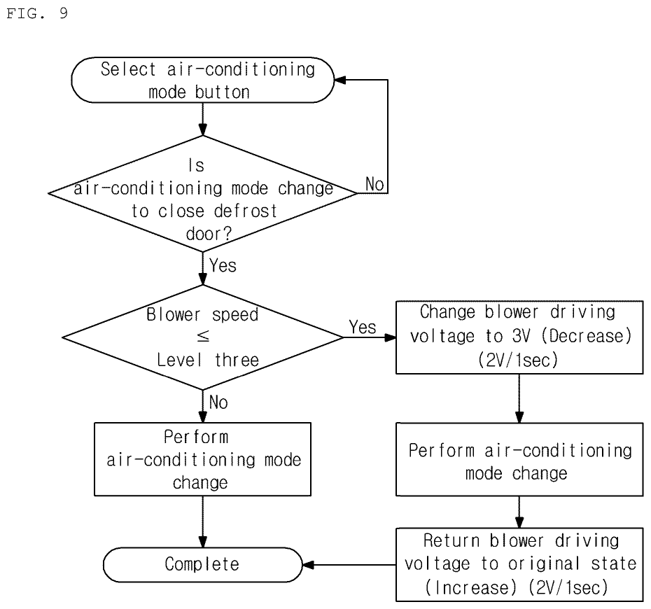

As illustrated in FIG. 9, when a signal to change the air-conditioning mode is input automatically or manually (e.g., by a passenger' pressing a button), the control unit 300 determines whether it is the air-conditioning mode change to close the defrost door 116. That is, when the air-conditioning mode is changed from the floor mode to the bilevel mode, or from the mix mode to the vent mode, or from the mix mode to the bilevel mode, or from the defrost mode to the vent mode, or from the defrost mode to the bilevel mode, the control unit 300 determines that the air-conditioning mode is changed to close the defrost door 116.

If the air-conditioning mode is changed to close the defrost door 116, the control unit 300 determines whether the current blower speed is below the level three (reference speed). If the current blower speed exceeds the level three, the control unit 300 performs the air-conditioning mode change immediately without any other action.

If the current blower speed is level three or below, the control unit 300 reduces the driving voltage of the blower 200 to the minimum value (for example, 3V). In this case, the control unit 300 uniformly reduces the driving voltage of the blower 200 by 2V per second. Thereafter, the control unit 300 performs the air-conditioning mode change. If the air-conditioning mode change from the mix mode to the vent mode is performed, the control unit 300 controls to close the defrost door 116 and open the vent door 117.

Thereafter, the control unit 300 increases the driving voltage of the blower 200 back to the original state (the voltage state before the air-conditioning mode change). In this case, the control unit 300 uniformly increases the driving voltage of the blower 200 by 2V per second.

While the vehicle air conditioner and the control method therefor of the present invention have been described with reference to the illustrated embodiments, the descriptions are exemplary only, and it will be understood by those skilled in the art that various modifications and equivalents of the embodiments are possible. Therefore, the true technical protection scope should be defined by the technical spirit of the appended claims.

What is claimed is:

1. An air conditioner for a vehicle comprising:
an air-conditioning case having an air passage formed therein and a plurality of air discharge ports;
a cooling heat exchanger and a heating heat exchanger provided in the air passage of the air-conditioning case;
an air blowing device having a blower which blows air into the interior of the air-conditioning case;
a plurality of mode doors adjusting the opening degree of the air discharge ports; and
a control unit controlling the operation of the mode doors,
wherein the control unit changes the air-conditioning mode after decreasing the airflow of the blower when changing the air-conditioning mode to close at least one mode door.

2. The air conditioner according to claim 1, wherein the control unit returns the airflow of the blower to the original state after the completion of the air-conditioning mode change.

3. The air conditioner according to claim 1, wherein the air discharge ports include a defrost vent for blowing air towards the window, a face vent for blowing air towards the face, and a floor vent for blowing air towards the feet,
wherein the mode doors include a defrost door which adjusts the opening degree of the defrost vent, and
wherein the one mode door is the defrost door.

4. The air conditioner according to claim 3, wherein the control unit reduces the airflow of the blower when the speed of the blower is below a reference speed and the defrost door moves to be closed.

5. The air conditioner according to claim 3, wherein the control unit reduces the blower driving voltage at a predetermined voltage rate per second.

6. The air conditioner according to claim 5, wherein the control unit increases the blower driving voltage at a predetermined voltage rate per second when returning the airflow of the blower to the original state after the completion of the air-conditioning mode change.

7. The air conditioner according to claim 5, wherein the control unit maintains the voltage of the blower displayed externally unchanged while reducing the blower driving voltage.

8. The air conditioner according to claim 3, wherein when the air-conditioning mode is changed from a floor mode to a bilevel mode, or from a mix mode to a vent mode, or from a mix mode to a bilevel mode, or from a defrost mode to a vent mode, or from a defrost mode to a bilevel mode, the control unit changes the air-conditioning mode after decreasing the airflow of the blower.

9. A method for controlling an air conditioner for a vehicle comprising the steps of:
determining whether a defrost door moves to be closed;
determining whether the speed of a blower of an air blowing device is below a reference speed;
reducing the airflow of the blower by a control unit when the speed of the blower is below a reference speed and the defrost door moves to be closed; and
changing an air-conditioning mode after reducing the airflow of the blower by the control unit.

10. The method for controlling the air conditioner according to claim 9, wherein the control unit returns the airflow of the blower to the original state after the completion of the air-conditioning mode change.

11. The method for controlling the air conditioner according to claim 9, wherein the control unit reduces the blower driving voltage at a predetermined voltage rate per second.

12. The method for controlling the air conditioner according to claim 11, wherein the control unit increases the blower driving voltage at a predetermined voltage rate per second when returning the airflow of the blower to the original state after the completion of the air-conditioning mode change.

13. The method for controlling the air conditioner according to claim 9, wherein the control unit maintains the voltage of the blower displayed externally unchanged while reducing the blower driving voltage.
